(19) United States
(12) Patent Application Publication
(10) Pub. No.: US 2025/0220127 A1
(43) Pub. Date: Jul. 3, 2025

(54) VIDEO PROCESSING METHOD, DEVICE, EQUIPMENT, AND STORAGE MEDIA

(71) Applicants: GUANGZHOU SHIYUAN ELECTRONIC TECHNOLOGY COMPANY LIMITED, Guangzhou (CN); GUANGZHOU SHIRUI ELECTRONICS CO., LTD., Guangzhou (CN)

(72) Inventors: Weizhe LI, Guangzhou (CN); Xiaolu ZHOU, Guangzhou (CN); Dinglong PAN, Guangzhou (CN)

(73) Assignees: GUANGZHOU SHIYUAN ELECTRONIC TECHNOLOGY COMPANY LIMITED, Guangzhou (CN); GUANGZHOU SHIRUI ELECTRONICS CO., LTD., Guangzhou (CN)

(21) Appl. No.: 19/086,067

(22) Filed: Mar. 20, 2025

Related U.S. Application Data
(63) Continuation of application No. PCT/CN2023/070746, filed on Jan. 5, 2023.

(51) Int. Cl. H04N 5/262

(52) U.S. Cl. CPC H04N 5/2628

(57) ABSTRACT

A video processing method, device, equipment, and storage medium are provided. The method includes: obtaining a portrait cropping request; performing portrait layout information recognition on a panoramic image frame corresponding to the portrait cropping request; performing portrait grouping on the panoramic image frame to acquire respective groups of similar portraits based on a preset principle of distance between the portrait and the camera and the portrait layout information; performing portrait cropping composition on the panoramic image frame to acquire respective portrait compositions based on respective groups of the similar portraits; and determining single frame display data based on the respective portrait compositions.

### CROSS-REFERENCE TO RELATED APPLICATION

The present application is a continuation of International Application No. PCT/CN2023/070746, filed on Jan. 5, 2023. The entire content of the above-identified application is expressly incorporated herein by reference.

### TECHNICAL FIELD

The present disclosure relates to the field of video processing technology, particularly to a video processing method, device, equipment, and storage medium.

### TECHNICAL BACKGROUND

With the development of Internet technology and electronic technology, video conferencing has been widely used. In a video conference, a captured panoramic image is directly presented. When the number of portraits in the panoramic image is greater than 1 and a distance between each portrait and the camera is different, the viewing experience is poor.

### SUMMARY

The main purpose of the present disclosure is to solve a technical problem that there is a problem with poor visual experience in existing video conferences, where panoramic images are directly presented, when the number of portraits in the panoramic image is greater than 1 and the distance between each portrait and the camera is different.

In order to achieve the above objects, the present disclosure proposes a video processing method, which includes:
obtaining a portrait cropping request;
performing portrait layout information recognition on a panoramic image frame corresponding to the portrait cropping request;
performing portrait grouping on the panoramic image frame to acquire respective groups of similar portraits based on a preset principle of distance between the portrait and the camera and the portrait layout information;
performing portrait cropping composition on the panoramic image frame to acquire respective portrait compositions based on respective groups of the similar portraits; and
determining single frame display data based on the respective portrait compositions.

Furthermore, before the step of obtaining a portrait cropping request, the method includes: obtaining the panoramic image frame;
if the number of portraits in the panoramic image frame is 0, taking the panoramic image frame as the single frame display data; and
generating the portrait cropping request based on the panoramic image frame when the number of portraits in the panoramic image frame is not 0.

Furthermore, the step of performing portrait grouping on the panoramic image frame to acquire respective groups of similar portraits based on a preset principle of distance between the portrait and the camera and the portrait layout information includes:
recognizing a distance between each portrait and the camera in the panoramic image frame to acquire a distance between the single portrait and the camera based on a preset distance calculation rule and the portrait layout information;
grouping the portraits in the panoramic image frame according to the principle of distance between the portrait and the camera and the distance between the single portrait and the camera based on a preset grouping index configuration, to acquire respective groups of the similar portraits;
where the grouping index configuration includes: a maximum camera distance absolute difference within the group is less than a preset first distance, and an average absolute difference of camera distances between groups is greater than a preset second distance; and
the distance calculation rule includes any one selected from a group consisting of a depth of a center point of the portrait, a maximum supported scaling factor, and an area of the portrait detection box.

Furthermore, the step of performing portrait cropping composition on the panoramic image frame to acquire respective portrait compositions based on respective groups of the similar portraits includes:
sorting respective groups of the similar portraits in positive order based on an average distance of a single group;
obtaining one group of similar portraits from the sorted respective groups of the similar portraits as a portrait group to be processed by using a manner of obtaining from the first one in order;
identifying two portraits having the maximum distance between the single portrait and the camera from the portrait group to be processed as a pair of farthest portraits;
performing separately merging and cropping composition and single-object cropping composition on the pair of farthest portraits based on a preset optimization principle of composition line and the panoramic image frame to acquire a first merged composition and two first single-object compositions;
if an actual scaling factor of the first merged composition is less than the sum of an actual scaling factor of any of the first single-object compositions and a preset first threshold, taking each of the first single object compositions as a subclass center, otherwise, taking the first merged composition as the subclass center;
obtaining one subclass center from the respective subclass centers as a center to be processed;
if there are portraits, in respective groups of the similar portraits, whose coverage rate of being covered by the portrait corresponding to the center to be processed exceeds a preset second threshold, taking a portrait whose coverage rate exceeds a preset second threshold as one object of the composition object pair, and taking respective portrait corresponding to the center to be processed as one object of the composition object pair;
if there are no portraits, in respective groups of the similar portraits, whose coverage rate of being covered by the portrait corresponding to the center to be processed exceeds the preset second threshold, taking respective portrait corresponding to the center to be processed as one object of the composition object pair, and taking the portrait that is closest to the center point of the center to be processed in the group to be processed as one object of the composition object pair;
performing separately merging and cropping composition and single-object cropping composition on the composition object based on the preset optimization principle of composition line and the panoramic image frame to acquire a second merged composition and two second single-object compositions;
if the actual scaling factor of the second merged composition is less than the sum of the actual scaling factor of any of the second single object compositions and the first threshold, taking each of the second single object compositions as the subclass center, otherwise, taking the second merged composition as the subclass center, and deleting the subclass center corresponding to the center to be processed;
repeating the step of obtaining one subclass center from the respective subclass centers as a center to be processed, until the subclass center corresponding to each portrait in the group to be processed is determined;
repeating the step of obtaining one group of similar portraits from the sorted respective groups of the similar portraits as a portrait group to be processed by using a manner of obtaining from the first one, until obtaining of respective groups of the similar portraits in respective groups of the similar portraits is completed; and
taking each of the subclass centers as the portrait composition.

Furthermore, the step of performing separately merging and cropping composition and single-object cropping composition on the pair of farthest portraits based on a preset optimization principle of composition line and the panoramic image frame to acquire a first merged composition and two first single-object compositions includes:
performing separately merging and cropping composition and single-object cropping composition on the panoramic image frame based on a preset cropping size and the pair of farthest portraits to obtain respective initial compositions;
drawing respective composition line for each of the initial compositions based on a preset drawing rule of composition line, where the drawing rule of composition line is that each of the composition lines is evenly distributed by 1/n of the image width and 1/m of the image height, and n and m are integers greater than 0;
adjusting an image magnification for each of the initial compositions based on the optimization principle of composition line, where the optimization principle of composition line is to adjust the image magnification so that a deviation value between a face position in an image and a closest horizontal composition line, and a deviation value between the face position in the image and a closest vertical composition line are both less than a preset third threshold;
if a cropping mode of the initial composition is merge cropping, taking the initial composition as the first merge composition; and
if the cropping mode of the initial composition is single-object cropping, taking the initial composition as the first single object composition.

Furthermore, the step of determining single frame display data based on the respective portrait compositions includes:
performing spatial mapping layout on the respective portrait compositions based on a preset layout determination rule and the number of portrait compositions to acquire the single frame display data;
where the layout determination rule includes minimizing a sum of distance differences; and
taking a position of a center point of the respective portrait compositions in the panoramic image frame as an original position, taking the position of the center point of the respective portrait compositions in the single frame display data as a layout position, taking a distance between the layout position of the same portrait composition and the original position as a distance difference, and adding the distance differences to obtain the sum of distance differences.

Furthermore, the step of determining single frame display data based on the respective portrait compositions includes:
obtaining a target audio data corresponding to the panoramic image frame, and performing sound source information recognition on the target audio data;
determining a target sound source personnel based on the sound source information and the portrait layout information;
if the target sound source personnel is absent, performing the spatial mapping layout on the respective portrait compositions based on the preset layout determination rule and the number of portrait compositions to acquire the single frame display data;
if the target sound source personnel is present, obtaining a transmission mode corresponding to the panoramic image frame;
if the transmission mode is single stream transmission, performing spatial mapping layout on the respective portrait compositions based on a preset speaker highlighting rules, the layout determination rule, the number of portrait compositions, and the target sound source personnel, to acquire the single frame display data; and
if the transmission mode is branched transmission, marking the portrait composition corresponding to the target sound source personnel and taking the respective portrait compositions as the single frame display data.

The present disclosure further proposes a video processing device, and the device includes:
a request obtaining module configured to obtain a portrait cropping request;
a recognition module configured to perform portrait layout information recognition on a panoramic image frame corresponding to the portrait cropping request;
a grouping module configured to perform portrait grouping on the panoramic image frame to acquire respective groups of similar portraits based on a preset principle of distance between the portrait and the camera and the portrait layout information;
a portrait cropping module configured to perform portrait cropping composition on the panoramic image frame to acquire respective portrait compositions based on respective groups of the similar portraits; and
a single-frame-display-data determining module configured to determine single frame display data based on the respective portrait compositions.

The present disclosure further proposes a computer device including a memory and a processor, where the memory stores a computer program, and the processor performs the steps of any one of the methods described above when the computer program is executed.

The present disclosure further proposes a computer-readable storage medium, on which a computer program is stored, where when the computer program is executed by a processor, the steps of any one of the methods described above are performed.

The video processing method, device, equipment, and storage medium of the present disclosure, the method performs portrait layout information recognition on a panoramic image frame corresponding to the portrait cropping request, performs portrait grouping on the panoramic image frame to acquire respective groups of similar portraits based on a preset principle of distance between the portrait and the camera and the portrait layout information, and then, performs portrait cropping composition on the panoramic image frame to acquire respective portrait compositions based on respective groups of the similar portraits, which achieves the use of the same cropping standard to acquire the respective portrait compositions, making the appearance of each portrait composition the same, and moreover, grouping first and then multiperson cutting improves the appearance of each portrait composition, thereby improving the visual experience of the single frame display data compared with the original panoramic image frame when determining single frame display data based on each portrait composition.

### BRIEF DESCRIPTION OF DRAWINGS

FIG. 1 is a flowchart of a video processing method according to an embodiment of the present disclosure.

FIG. 2 is a block diagram of a video processing device according to an embodiment of the present disclosure.

FIG. 3 is a block diagram of a computer device according to an embodiment of the present disclosure.

The implementation, functional characteristics, and advantages of the purpose of the present disclosure will be further described in conjunction with the embodiments and with reference to the accompanying drawings.

### DETAILED DESCRIPTION

In order to make the purpose, technical solution, and advantages of the present disclosure clearer and more understandable, the following will provide further detailed description of the present disclosure in conjunction with the accompanying drawings and embodiments. It should be understood that the specific embodiments described herein are only used to describe the present disclosure and are not intended to limit the present disclosure.

In the system architecture diagram for implementing the video processing method of the present disclosure, the system architecture diagram includes: a microphone component, a camera component, and a processor. The microphone component, with a communication connection to the processor, is configured to collect audio information from the venue; the camera component, with a communication connection to the processor, is configured to capture panoramic images of the conferencing place; the microphone component includes one or more microphones; the camera component includes one or more cameras. It may be understood that in the system architecture diagram, the processor may be either a server-end processor or a terminal processor.

In some implementations, the microphone component adopts a microphone array. The microphone array determines a position of a sound source based on a phased array principle by measuring the phase difference of the sound waves reaching each microphone in the space of the conferencing place. The main purpose of microphone array is to locate the sound source information in the conferencing place and calculate a sound source orientation angle. The layout of the microphone array may be one or a combination of linear array, planar array, or stereo array.

A camera in the camera component may be a fixed focus camera, a zoom camera, or an integration of both (i.e., fixed focus camera, zoom camera). Generally, the camera of the camera component is located at a geometric center of the microphone array.

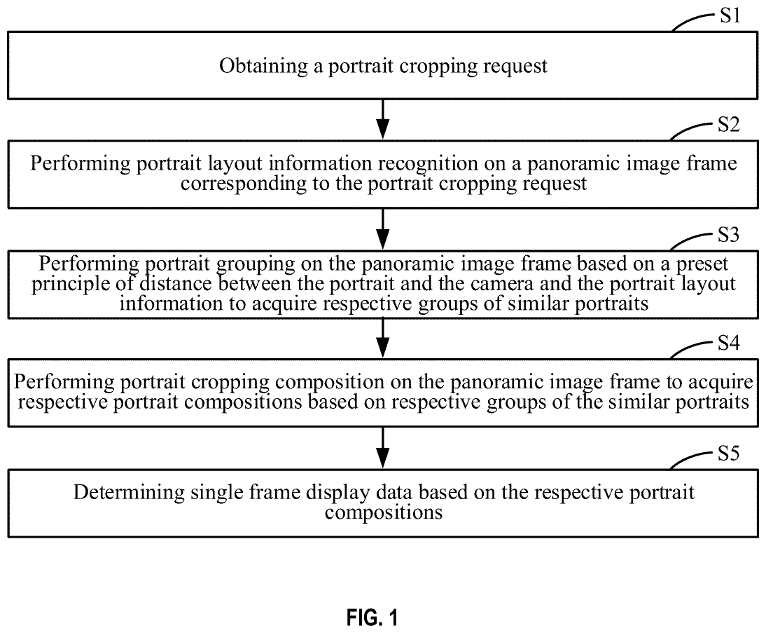

Referring to FIG. 1, an embodiment of the present disclosure provides a video processing method, which includes:

S1: obtaining a portrait cropping request;

In some implementations, it may trigger directly the portrait cropping request when obtaining a panoramic image frame, or it may trigger the portrait cropping request according to a preset triggering rule based on obtained the panoramic image frame. For example, the triggering rule is to trigger the portrait cropping request when the number of portraits in the panoramic image frame is not zero.

A panoramic image frame is a frame of panoramic image. Multiple panoramic image frames that are temporally correlated form a video stream.

S2: performing portrait layout information recognition on a panoramic image frame corresponding to the portrait cropping request;

The portrait layout information refers to the distribution of portraits, and the portrait layout information includes orientation information of each portrait in the panoramic image frame.

It is to detect the panoramic image frame corresponding to the portrait cropping request based on a portrait detection model, and calculate the orientation information of the portrait based on a center point of each detected portrait detection box.

The portrait detection model is used to detect a portrait and generate a portrait detection box. The portrait detection model is a model trained based on an object detection model.

The portrait detection box is a rectangular or square box. The image regions corresponding to the portrait in the panoramic image frame are all located within the portrait detection box corresponding to that portrait.

S3: performing portrait grouping on the panoramic image frame to acquire respective groups of similar portraits based on a preset principle of distance between the portrait and the camera and the portrait layout information;

Due to the fact that the constructed portraits follow the rule of “near big, far small” when the camera recognizes portraits in the conferencing place, it is necessary to reasonably separate people from different distances. For example, the upper limit of the number of groups G is first given, and the portraits in the panoramic image frame are divided into G groups at most.

The principle of distance between the portrait and the camera is that the farther the portrait is from the camera, the smaller the portrait, and the closer the portrait is to the camera, the larger the portrait.

It is to recognize the distance between each portrait in the panoramic image frame and the camera based on the portrait layout information, and take this distance as the distance between the single portrait camera; performing the portrait grouping based on the preset principle of distance between the portrait and the camera, and the distance between each single portrait camera, and taking each group as a similar portrait group so as to make the distance between each portrait in each similar portrait group and the camera relatively close.

S4: performing portrait cropping composition on the panoramic image frame to acquire respective portrait compositions based on respective groups of the similar portraits.

It is to, for respective groups of the similar portraits, perform portrait cropping composition on the panoramic image frame to obtain all portrait compositions, which implements the use of the same cutting criteria to acquire each portrait composition, resulting in the same visual experience for each portrait composition.

Each portrait composition includes at least one portrait.

S5: determining single frame display data based on the respective portrait compositions.

In some implementations, it is to take directly the respective portrait compositions as single frame display data. This is beneficial for other applications (such as applications in display devices) to display the respective portrait compositions in a single frame display data.

In some implementations, it is to perform spatial mapping layout on the respective portrait compositions to acquire the single frame display data. This is beneficial for other applications (such as applications in display devices) to directly the display single frame display data.

This embodiment performs portrait layout information recognition on a panoramic image frame corresponding to the portrait cropping request, performs portrait grouping on the panoramic image frame to acquire respective groups of similar portraits based on a preset principle of distance between the portrait and the camera and the portrait layout information, and then, performs portrait cropping composition on the panoramic image frame to acquire respective portrait compositions based on respective groups of the similar portraits, which achieves the use of the same cropping standard to acquire the respective portrait compositions, making the appearance of each portrait composition the same, and moreover, and grouping first and then multiperson cutting improves the appearance of each portrait composition, thereby improving the visual experience of the single frame display data compared with the original panoramic image frame when determining single frame display data based on each portrait composition.

In one embodiment, before the step of obtaining a portrait cropping request, the method includes:

S11: obtaining the panoramic image frame;

It may obtain the panoramic image frame captured by a single camera, and it also may obtain image frames captured by each of the cameras at the same time point, stitch all image frames, and take the stitched data as the panoramic image frame.

Based on the portrait detection model, it is possible to detect whether there are portraits in the panoramic image frame. If there are no portraits, it is determined that the number of portraits in the panoramic image frame is 0. If there are, it is determined that the number of portraits in the panoramic image frame is not 0.

S12: if the number of portraits in the panoramic image frame is 0, taking the panoramic image frame as the single frame display data;

In some implementations, if the number of portraits in the panoramic image frame is 0, that is, there are no participants in the conference in the panoramic image frame, no portraits is capable of being used for the portrait cropping composition. Therefore, the panoramic image frame is directly taken as the single frame display data.

S13: generating the portrait cropping request based on the panoramic image frame when the number of portraits in the panoramic image frame is not 0.

In some implementations, if the number of portraits in the panoramic image frame is not 0, that is, if there are participants in the conference in the panoramic image frame, there are portraits capable of being used for the portrait cropping composition. Therefore, the portrait cropping request is generated based on the panoramic image frame.

It may be understood that the panoramic image frame may be stored in a preset storage space, and then the image identifier of the panoramic image frame may be taken as the parameter carried by the portrait cropping request; the panoramic image frame may also be taken as a data packet for the portrait cropping request.

In this embodiment, a portrait cropping request is generated only when there are participants at the conferencing place. If there are no participants at the conference place, the panoramic image frame is directly taken as the single frame display data, thereby reducing unnecessary portrait cropping composition operations and reducing computational complexity.

In one embodiment, the step of performing portrait grouping on the panoramic image frame to acquire respective groups of similar portraits based on a preset principle of distance between the portrait and the camera and the portrait layout information includes:

S31: recognizing a distance between each portrait and the camera in the panoramic image frame to acquire a distance between the single portrait and the camera based on a preset distance calculation rule and the portrait layout information.

In some implementations, based on the preset distance calculation rule, the distance calculation method may be determined. Based on the determined method and the portrait layout information, the distance between each portrait and the camera in the panoramic image frame may be calculated, and the calculated distance is taken as the distance between the single portrait and the camera.

S32: grouping the portraits in the panoramic image frame according to the principle of distance between the portrait and the camera and the distance between the single portrait and the camera based on a preset grouping index configuration, to acquire respective groups of the similar portraits.

The grouping index configuration includes: a maximum camera distance absolute difference within the group is less than a preset first distance, and an average absolute difference of camera distances between groups is greater than a preset second distance.

The distance calculation rule includes any one selected from a group consisting of a depth of a center point of the portrait, a maximum supported scaling factor, and an area of the portrait detection box.

It is to group the portraits in the panoramic image frame according to the principle of distance between the portrait and the camera and the distance between the single portrait and the camera based on a preset grouping index configuration, and take each portrait corresponding to the same group as one groups of similar portraits.

The difference between the distances of two single portrait cameras is calculated within the distance between the single portrait and the camera corresponding to one groups of similar portraits, the absolute value of each difference is calculated to acquire the absolute difference of camera distances, the maximum absolute difference of camera distances is extracted from each of the absolute differences of camera distances, and the extracted absolute difference of camera distances is taken as the maximum absolute difference of camera distances within the group corresponding to the similar portrait group.

The average distance is calculated between each distance between the single portrait and the camera corresponding to respective groups of the similar portraits, to obtain the average distance of each group, the difference between average distances of two single groups is calculated, and the absolute value of the difference is calculated to obtain the absolute difference of the average distances between the cameras in each group.

The depth of the center point of a portrait is the depth of a pixel point corresponding to the center point of the portrait detection box in the panoramic image frame.

The maximum scaling factor refers to the scaling factor of an image region corresponding to the portrait when the cropping box precisely frames the image corresponding to the portrait in a cropping box corresponding to a preset cropping size; when the scaling factor is greater than 1, it is a magnification factor, and when the scaling factor is less than 1, it is a reduction factor.

It may be understood that the distance calculation rule may also adopt other calculation rules, which are not limited here.

This embodiment groups the portraits in the panoramic image frame according to the principle of distance between the portrait and the camera and the distance between the single portrait and the camera based on a preset grouping index configuration, to acquire respective groups of the similar portraits, which improves the correlation within each similar portrait group and also enhances the discrimination between different similar portrait groups, thereby providing a foundation for accurate portrait cropping composition based on grouping in the future.

In one embodiment, the steps of performing portrait cropping composition on the panoramic image frame to acquire respective portrait compositions based on respective groups of the similar portraits includes:

S41: sorting respective groups of the similar portraits in positive order based on an average distance of a single group;

It is to calculate the average distance of each single portrait camera corresponding to respective groups of the similar portraits to acquire the average distance of a single group; and sorting respective groups of the similar portraits in positive order based on the average distance of the single group.

S42: obtaining one group of similar portraits from the sorted respective groups of the similar portraits as a portrait group to be processed by using a manner of obtaining from the first one in order.

It is to achieve extraction starting from the closest similar portrait group to the camera by using the manner of obtaining from the first one.

S43: identifying two portraits having the maximum distance between the single portrait and the camera from the portrait group to be processed as a pair of farthest portraits.

It is to identify the two portraits having the maximum distance between the single portrait and the camera from the portrait group to be processed as the pair of farthest portraits, and take the extracted two portraits as two composition objects, so as to achieve composition analysis starting from the two farthest portraits in each group.

S44: performing separately merging and cropping composition and single-object cropping composition on the pair of farthest portraits based on a preset optimization principle of composition line and the panoramic image frame to acquire a first merged composition and two first single-object compositions.

The optimization principle of composition line is to adjust the magnification of the image so that the deviation value between the facial position in the image and the closest horizontal composition line, and the deviation value between the facial position and the closest vertical composition line are both less than the preset third threshold, thereby enhancing the visual effect of the composition.

Each of the composition lines is distributed equidistant by 1/n of the image width and 1/m of the image height, where n and m are integers greater than 0, and M may or may not be equal to n.

It is to perform merging and cropping composition on the panoramic image frame based on the preset optimization principle of composition line, so that the composition includes the image region corresponding to the pair of farthest portraits, and take this composition as the first merged composition; perform single-object cropping composition on the panoramic image frame based on the preset optimization principle of composition line, so that the composition includes the image region corresponding to the first portrait in the pair of farthest portraits, and take this composition as the first single-object composition; and perform single-object cropping composition on the panoramic image frame based on the preset optimization principle of composition line, so that the composition includes the image region corresponding to the second portrait in the pair of farthest portraits, and take this composition as the second single-object composition.

S45: if an actual scaling factor of the first merged composition is less than the sum of an actual scaling factor of any of the first single-object compositions and a preset first threshold, taking each of the first single object compositions as a subclass center, otherwise, taking the first merged composition as the subclass center.

The actual scaling factor of the first merged composition is the actual scaling factor of the portrait in the first merged composition.

It is to add the actual scaling factor of each first single object composition to a preset first threshold to acquire a single image adjustment value; if the actual scaling factor of the first merged composition is less than the adjustment value of any single portrait, it means that the pair of farthest portraits are not capable of being composed together, and therefore, take each of the first single object compositions as the center of the subclass; and if the actual scaling factor of the first merged composition is greater than or equal to the adjustment values of all single images, it means that the pair of farthest portraits are capable of being composed together, and therefore, take the first merged composition as the subclass center.

In some implementations, the first threshold is set to 0.1.

S46: obtaining one subclass center from the respective subclass centers as a center to be processed.

S47: if there are portraits, in respective groups of the similar portraits, whose coverage rate of being covered by the portrait corresponding to the center to be processed exceeds a preset second threshold, taking a portrait whose coverage rate exceeds a preset second threshold as one object of the composition object pair, and taking respective portrait corresponding to the center to be processed as one object of the composition object pair.

The coverage rate is a value acquired by dividing an area covered by the covered object by the total area of the image region corresponding to the covered object.

It is to if there are portraits (i.e., covered objects), in respective groups of the similar portraits, whose coverage rate of being covered by the portrait corresponding to the center to be processed exceeds a preset second threshold, it means that the most important object to consider whether to compose together has been found, and therefore, take the portraits (i.e., covered objects) whose coverage rate exceeds the preset second threshold as one object of the composition object pair, and take respective portrait corresponding to the center to be processed as one object of the composition object pair.

In some implementations, the second threshold is set to 50%.

S48: if there are no portraits, in respective groups of the similar portraits, whose coverage rate of being covered by the portrait corresponding to the center to be processed exceeds the preset second threshold, taking respective portrait corresponding to the center to be processed as one object of the composition object pair, and taking the portrait that is closest to the center point of the center to be processed in the group to be processed as one object of the composition object pair.

It is to if there are no portraits (i.e., covered objects), in respective groups of the similar portraits, whose coverage rate of being covered by each portrait (i.e., covered objects) corresponding to the center to be processed exceeds the preset second threshold, it means that the objects of this group (i.e., the portrait group to be processed) need to be found to consider whether to compose together, take respective portrait corresponding to the center to be processed as one object of the composition object pair, and take the portrait closest to the center point of the center to be processed in the portrait group to be processed as one object of the composition object pair.

It may be understood that the distance in the step of the portrait that is closest to the center point of the center to be processed in the group to be processed refers to the distance in the venue space, which may be calculated through the layout information of the portraits and the distance between the single portrait camera.

S49: performing separately merging and cropping composition and single-object cropping composition on composition object based on the preset optimization principle of composition line and the panoramic image frame to acquire a second merged composition and two second single-object compositions.

It is to performing merging and cropping composition on the panoramic image frame based on the preset optimization principle of composition line, so that the composition includes the image region corresponding to the composition object pair, and take this composition as the second merged composition; perform single-object cropping composition on the panoramic image frame based on the preset optimization principle of composition line, so that the composition includes the image region corresponding to the first object pair in the composition object pair, and take this composition as a first second-single-object-composition; and perform single-object cropping composition on the panoramic image frame based on the preset optimization principle of composition line, so that the composition includes the image region corresponding to the second object pair in the composition object pair, and take this composition as a second second-single-object-composition.

S410: if the actual scaling factor of the second merged composition is less than the sum of the actual scaling factor of any of the second single object compositions and the first threshold, taking each of the second single object compositions as the subclass center, otherwise, taking the second merged composition as the subclass center, and deleting the subclass center corresponding to the center to be processed.

It is to add the actual scaling factor of each of the second single object compositions to the preset first threshold to acquire the single object adjustment value; if the actual scaling factor of the second merged composition is less than any of the single object adjustment values, it means that the composition objects are not capable of being composed together, and therefore, take each of the second single object compositions as the subclass center; if the actual scaling factor of the second merged composition is greater than or equal to the adjustment values of all single objects, it means that the composition object pairs are capable of being composed together, and therefore, take the second merged composition as the subclass center; since it is considered that the composition objects are composed together, and there is no need for the subclass centers corresponding to the center to be processed to exist separately at this time, delete the subclass centers corresponding to the center to be processed, providing a basis for ensuring that the final preserved subclass centers meet the requirements of the composition.

S411: repeating the step of obtaining one subclass center from the respective subclass centers as a center to be processed, until the subclass center corresponding to each portrait in the group to be processed is determined;

It is to repeat the step of obtaining one subclass center from the respective subclass centers as a center to be processed, that is, repeat steps S46 to S411 until the subclass center corresponding to each portrait in the group to be processed is determined; when the subclass center corresponding to each portrait in the portrait group to be processed is determined, it means that the most suitable composition has been found for each portrait in the portrait group to be processed, so that it is necessary to stop repeating steps S46 to S411 and start executing step S412.

S412: repeating the step of obtaining one group of similar portraits from the sorted respective groups of the similar portraits as a portrait group to be processed by using a manner of obtaining from the first one in order, until obtaining of respective groups of the similar portraits in respective groups of the similar portraits is completed.

It is to repeat the step of obtaining one group of similar portraits from the sorted respective groups of the similar portraits as a portrait group to be processed by using a manner of obtaining from the first one in order, that is, repeat steps S42 to S412, until obtaining of respective groups of the similar portraits in respective groups of the similar portraits is completed; when the obtaining of each similar portrait group is completed, it means that the most suitable composition has been found for each portrait in the panoramic image frame, so that it is necessary to stop repeating steps S42 to S412 and start executing step S413.

S413: taking each of the subclass centers as the portrait composition.

In some implementations, in step S410, the subclass centers that do not meet the requirements for single object cropping and composition have been deleted. After performing step S412, the remaining subclass centers are all subclass centers that meet the requirements for cropping composition. Therefore, each of the subclass centers is taken as the portrait composition, resulting in the same appearance for each portrait composition.

This embodiment achieves the use of the same segmentation criteria to acquire each portrait composition, making the appearance of each portrait composition the same, and first grouping and then multiperson cutting improves the appearance of each portrait composition.

In one embodiment, the step of performing separately merging and cropping composition and single-object cropping composition on the pair of farthest portraits based on a preset optimization principle of composition line and the panoramic image frame to acquire a first merged composition and two first single-object compositions includes:

S441: performing separately merging and cropping composition and single-object cropping composition on the panoramic image frame based on a preset cropping size and the pair of farthest portraits to obtain respective initial compositions.

It is to construct a cropping box based on the preset cropping size, and perform separately merging and cropping composition and single-object cropping composition on the panoramic image frame, and tale the acquired compositions as an initial composition.

S442: drawing respective composition line for each of the initial compositions based on a preset drawing rule of composition line, where the drawing rule of composition line is that each of the composition lines is evenly distributed by 1/n of the image width and 1/m of the image height, and n and m are integers greater than 0.

It is to draw respective composition line for each of the initial compositions based on a preset drawing rule of composition line, so as to generate horizontal and vertical composition lines. For example, if both m and n are 1, the two composition lines of the initial composition divide the initial composition into four equal parts, and the two composition lines intersect vertically. For example, if both m and n are 2, the four composition lines of the initial composition divide the initial composition into nine equal parts to form a nine grid.

S443: adjusting an image magnification for each of the initial compositions based on the optimization principle of composition line, where the optimization principle of composition line is to adjust the image magnification so that a deviation value between a face position in an image and a closest horizontal composition line, and a deviation value between the face position in the image and a closest vertical composition line are both less than a preset third threshold.

The horizontal closest composition line is the composition line closest to the face position among each of the composition lines parallel to the width of the image. The vertical closest composition line is the composition line closest to the face position among each of the composition lines that are highly parallel to the image.

For example, both m and n are 2, if the center point of the face position in the image deviates from the closest composition line (i.e., the horizontal or vertical closest composition line) by a third threshold, it is determined that there has been a personnel change; if the center point of the face position in the image is located between the center point of the image and the closest composition line (i.e., the horizontal or vertical closest composition line) to achieve inward deviation, the image magnification is increased to ensure that the face in the image is close to the top one-third of the composition line, and secondly, the lower portrait is as close as possible to but not lower than the bottom ⅓ of the composition line; if the closest composition line (i.e., the horizontal or vertical closest composition line) is located between the center point of the face position in the image and the center point of the image to achieve outward deviation, the image magnification needs to be reduced. If the person deviates too much or even approaches the edge of the image, no scaling will be performed; if the center point of the face position in the image deviates from the closest composition line (i.e., the horizontal or vertical closest composition line) by no more than the third threshold, the image magnification is not adjusted.

S444: if a cropping mode of the initial composition is merge cropping, taking the initial composition as the first merge composition.

S445: if the cropping mode of the initial composition is single-object cropping, taking the initial composition as the first single object composition.

This embodiment first adjusts the image magnification of each of the initial compositions based on the optimization principle of composition line, and then takes the initial composition as the first merged composition or the first single object composition to optimize the appearance of characters in the sub picture (i.e., the first merged composition or the first single object composition).

In one embodiment, the step of determining single frame display data based on the respective portrait compositions includes:

S511: performing spatial mapping layout on the respective portrait compositions based on a preset layout determination rule and the number of portrait compositions to acquire the single frame display data.

The layout determination rule includes minimizing the sum of distance differences.

The position of the center point of the respective portrait compositions in the panoramic image frame is taken as the original position, the position of the center point of the respective portrait compositions in the single frame display data is taken as the layout position, the distance between the layout position of the same portrait composition and the original position is taken as the distance difference, and the distance differences are added to acquire the sum of distance differences.

It is to determine the number of required partition areas based on the number of portrait compositions, and perform layout region dividing on the layout interface based on the number of regions, fill a portrait composition in each layout region, and determine the single frame display data based on the data in the completed layout region based on preset layout determination rules.

In some implementations, an image may be generated from all the layout regions that have been filled, and this image may be taken as the single frame display data.

In some implementations, the data of each layout region that has been filled is taken as one data packet, and each data packet is taken as the single frame display data.

In some implementations, the size of each layout area is consistent.

In some implementations, when viewing each composition, the portrait appear close to real person size. This further enhances the visual experience.

This embodiment uses minimizing the total distance difference as the layout determination rule to ensure consistency between sorting and panoramic image frames, thereby maintaining the portrait order of the conferencing place for the single frame display data and improving visual experience of the single frame display data.

In one embodiment, the step of determining single frame display data based on the respective portrait compositions includes:

S521: obtaining a target audio data corresponding to the panoramic image frame, and performing sound source information recognition on the target audio data.

In some implementations, the target audio data corresponding to the panoramic image frame is the audio data collected by the camera component at the shooting time corresponding to the panoramic image frame.

The sound source information includes the number of speakers in the target audio data and the corresponding sound source orientation angles for each speaker.

S522: determining a target sound source personnel based on the sound source information and the portrait layout information.

It is to determine the target sound source personnel corresponding to the target sound source orientation angle in the portrait layout information based on the target sound source orientation angle in the sound source information.

The orientation angle of the target sound source is the range of azimuth angles of the sound source in the target audio data.

The portrait layout information refers to the distribution of personnel in the panoramic image, that is, regions are divided into based on azimuth angles in the panoramic image, and each personnel is located in different azimuth angles.

The target sound source personnel refer to the personnel who produce sound in the panoramic image frame and whose sound source is captured in the target audio data.

It may be understood that the orientation angle of the target sound source corresponds to the same spatial coordinate system as the portrait layout information. Based on the orientation angle of the target sound source in the target audio data, the range of azimuth angles corresponding to the speaker may be determined. Based on the range of azimuth angles corresponding to the speaker, the target sound source personnel located within this range may be determined in the portrait layout information.

S523: if the target sound source personnel is absent, performing the spatial mapping layout on the respective portrait compositions based on the preset layout determination rule and the number of portrait compositions to acquire the single frame display data.

In some implementations, if the target sound source personnel is absent, it means that no one is speaking and there is no need to highlight the speaker. Therefore, based on the preset layout rules and the number of portrait compositions, spatial mapping layout is applied to the respective portrait compositions to acquire the single frame display data.

S524: if the target sound source personnel is present, obtaining a transmission mode corresponding to the panoramic image frame.

In some implementations, if the target sound source personnel is present, it means that someone is speaking and speaker highlighting is required. Therefore, the transmission mode corresponding to the panoramic image frame is obtained.

The transmission mode may be single stream transmission or split stream transmission. Single stream transmission refers to the transmission of the entire single frame display data through a single data channel or packet. Branched transmission refers to transmitting the data corresponding to each portrait composition through a separate data channel or packet.

S525: if the transmission mode is single stream transmission, performing spatial mapping layout on the respective portrait compositions based on a preset speaker highlighting rules, the layout determination rule, the number of portrait compositions, and the target sound source personnel, to acquire the single frame display data.

In some implementations, if the transmission mode is single stream transmission, it means that the speaker highlighting needs to be adjusted first. Therefore, based on the preset speaker highlighting rules, layout determination rules, the number of portrait compositions, and the target sound source personnel, spatial mapping layout is applied to the respective portrait compositions to acquire the single frame display data.

The speaker highlighting rules include but are not limited to: adjustment of the region area, setting of a specific color, setting of a dynamic effect and the border, and setting of one or more specific formats.

S526: if the transmission mode is branched transmission, marking the portrait composition corresponding to the target sound source personnel and taking the respective portrait compositions as the single frame display data.

In some implementations, if the transmission mode is branched transmission, the portrait composition corresponding to the target sound source personnel is marked, the respective portrait compositions is taken as the single frame display data, providing a basis for supporting layout effects in other applications (such as applications in display devices).

This embodiment sets different highlighting manners for different transmission modes, providing flexible choices for different display devices in the present disclosure; by highlighting the speaker, it is beneficial for viewers to quickly find the corresponding image region of the speaker, which improves the visual experience.

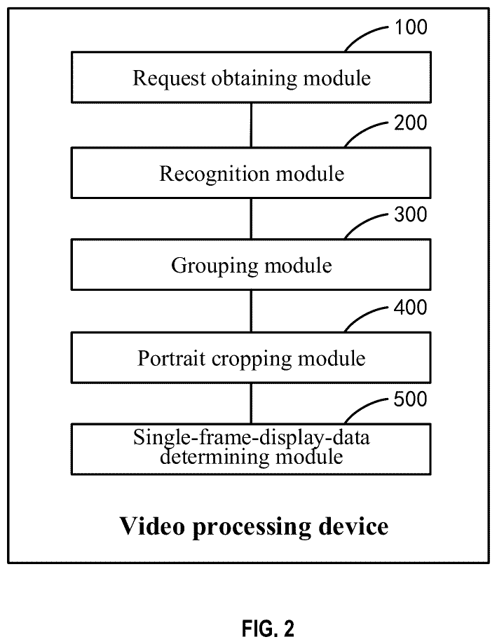

Referring to FIG. 2, the present disclosure further proposes a video processing device, which includes:
a request obtaining module 100 configured to obtain a portrait cropping request;
a recognition module 200 configured to perform portrait layout information recognition on a panoramic image frame corresponding to the portrait cropping request;
a grouping module 300 configured to perform portrait grouping on the panoramic image frame to acquire respective groups of similar portraits based on a preset principle of distance between the portrait and the camera and the portrait layout information;
a portrait cropping module 400 configured to perform portrait cropping composition on the panoramic image frame to acquire respective portrait compositions based on respective groups of the similar portraits;
a single-frame-display-data determining module 500 configured to determine single frame display data based on the respective portrait compositions.

This embodiment performs portrait layout information recognition on a panoramic image frame corresponding to the portrait cropping request, performs portrait grouping on the panoramic image frame to acquire respective groups of similar portraits based on a preset principle of distance between the portrait and the camera and the portrait layout information, and then, performs portrait cropping composition on the panoramic image frame to acquire respective portrait compositions based on respective groups of the similar portraits, which achieves the use of the same cropping standard to acquire the respective portrait compositions, making the appearance of each portrait composition the same, and moreover, grouping first and then multiperson cutting improves the appearance of each portrait composition, thereby improving the visual experience of the single frame display data compared with the original panoramic image frame when determining single frame display data based on each portrait composition.

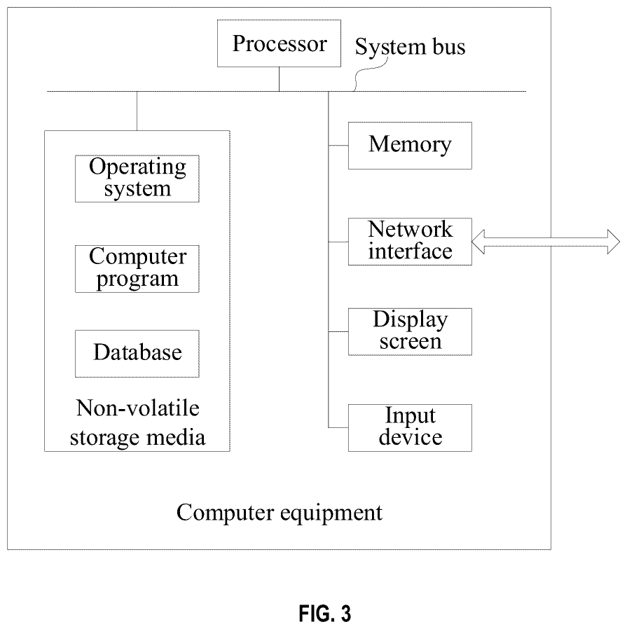

Referring to FIG. 3, the present embodiment further provides a computer device, which may be a server, and its internal structure may be as shown in FIG. 3. The computer device includes a processor, a memory, a network interface, and a database connected through a system bus. The processor designed by the computer is configured to provide computing and control capabilities. The memory of the computer device includes non-volatile storage media and internal memory. This non-volatile storage medium stores operating systems, computer programs, and databases. This memory provides an environment for the operation of operating systems and computer programs in non-volatile storage media. The database of this computer device is configured to store data such as video processing methods. The network interface of this computer device is configured to communicate with external terminals through a network connection. This computer program is executed by a processor to implement a video processing method. The video processing method includes: obtaining a portrait cropping request; performing portrait layout information recognition on a panoramic image frame corresponding to the portrait cropping request; performing portrait grouping on the panoramic image frame to acquire respective groups of similar portraits based on a preset principle of distance between the portrait and the camera and the portrait layout information; performing portrait cropping composition on the panoramic image frame to acquire respective portrait compositions based on respective groups of the similar portraits; and determining single frame display data based on the respective portrait compositions.

This embodiment performs portrait layout information recognition on a panoramic image frame corresponding to the portrait cropping request, performs portrait grouping on the panoramic image frame to acquire respective groups of similar portraits based on a preset principle of distance between the portrait and the camera and the portrait layout information, and then, performs portrait cropping composition on the panoramic image frame to acquire respective portrait compositions based on respective groups of the similar portraits, which achieves the use of the same cropping standard to acquire the respective portrait compositions, making the appearance of each portrait composition the same, and moreover, grouping first and then multiperson cutting improves the appearance of each portrait composition, thereby improving the visual experience of the single frame display data compared with the original panoramic image frame when determining single frame display data based on each portrait composition.

An embodiment of the present disclosure further provides a computer-readable storage medium on which a computer program is stored. When the computer program is executed by a processor, a video processing method is performed, including the steps of: obtaining a portrait cropping request; performing portrait layout information recognition on a panoramic image frame corresponding to the portrait cropping request; performing portrait grouping on the panoramic image frame to acquire respective groups of similar portraits based on a preset principle of distance between the portrait and the camera and the portrait layout information; performing portrait cropping composition on the panoramic image frame to acquire respective portrait compositions based on respective groups of the similar portraits; and determining single frame display data based on the respective portrait compositions.

The video processing method described above performs portrait layout information recognition on a panoramic image frame corresponding to the portrait cropping request, performs portrait grouping on the panoramic image frame to acquire respective groups of similar portraits based on a preset principle of distance between the portrait and the camera and the portrait layout information, and then, performs portrait cropping composition on the panoramic image frame to acquire respective portrait compositions based on respective groups of the similar portraits, which achieves the use of the same cropping standard to acquire the respective portrait compositions, making the appearance of each portrait composition the same, and moreover, grouping first and then multiperson cutting improves the appearance of each portrait composition, thereby improving the visual experience of the single frame display data compared with the original panoramic image frame when determining single frame display data based on each portrait composition.

Those skilled in the art can understand that all or a part of the processes in the method of implementing the above embodiments can be completed by instructing relevant hardware through a computer program, which can be stored in a nonvolatile computer readable storage medium. When the computer program is executed, it can include the processes of the embodiments of the above-mentioned methods. Any reference to memory, storage, database or other media provided in the present disclosure and used in the embodiments may include nonvolatile and/or volatile memory. The nonvolatile memory may include read only memory (ROM), programmable ROM (PROM), electrically erasable programmable ROM (EEPROM), or flash memory. The volatile memory may include random access memory (RAM) or external cache memory. By way of illustration and not limitation, RAM is available in various forms, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), Rambus direct RAM (RDRAM), Direct Rambus DRAM (DRDRAM), and Rambus Dynamic RAM (RDRAM).

It should also be noted that the terms “include,” “comprise” or any other variants thereof are intended to cover non-exclusive inclusion, so that a process, device, first article or method including a series of elements not only includes those elements, but also includes other elements that are not explicitly listed, or also include elements inherent to such processes, devices, first articles or methods. If there are no more restrictions, the element defined by the sentence “including a . . . ” does not exclude the existence of other identical elements in the process, device, first article or method that includes the element.

The above is only some embodiments of the present disclosure, and does not limit the claimed scope of the present disclosure. Any equivalent structure or equivalent flow transformation made by using the description and drawings of the present disclosure, or directly or indirectly applied in other relevant technical fields, are also included in the claimed scope of the present disclosure.

What is claimed is:

1. A video processing method, comprising:
obtaining a portrait cropping request;
performing portrait layout information recognition on a panoramic image frame corresponding to the portrait cropping request;
performing portrait grouping on the panoramic image frame to acquire respective groups of similar portraits based on a preset principle of a distance between each portrait and a camera, and the portrait layout information;
performing portrait cropping composition on the panoramic image frame to acquire respective portrait compositions based on the respective groups of the similar portraits; and
determining single frame display data based on the respective portrait compositions.

2. The video processing method of claim 1, wherein before the obtaining the portrait cropping request, the method further comprises:
obtaining the panoramic image frame;
when the number of the portraits in the panoramic image frame is 0, taking the panoramic image frame as the single frame display data; and
when the number of the portraits in the panoramic image frame is not 0, generating the portrait cropping request based on the panoramic image frame.

3. The video processing method of claim 1, wherein the performing portrait grouping on the panoramic image frame to acquire the respective groups of similar portraits based on the preset principle of the distance between each portrait and the camera, and the portrait layout information further comprises:
recognizing a distance between each portrait and the camera in the panoramic image frame to acquire a distance between the single portrait and the camera based on a preset distance calculation rule and the portrait layout information;
grouping the portraits in the panoramic image frame according to the preset principle of the distance between each portrait and the camera, and the distance between the single portrait and the camera, and further based on a preset grouping index configuration, to acquire the respective groups of the similar portraits;
wherein the preset grouping index configuration comprises: a maximum camera distance absolute difference within one of the groups is less than a preset first distance, and an average absolute difference of camera distances between each two of the groups is greater than a preset second distance; and
the preset distance calculation rule comprises any one of a depth of a center point of the portrait, a maximum supported scaling factor, or an area of a portrait detection box.

4. The video processing method of claim 1, wherein the performing portrait cropping composition on the panoramic image frame to acquire the respective portrait compositions based on the respective groups of the similar portraits further comprises:
sorting the respective groups of the similar portraits in positive order based on an average distance of each group;
obtaining one of the groups of the similar portraits from the sorted respective groups of the similar portraits as a portrait group to be processed by using a manner of obtaining from the first one in the order;
identifying two portraits having a maximum distance between the single portrait and the camera from the portrait group to be processed as a pair of farthest portraits;
performing separately merging and cropping composition and single-object cropping composition on the pair of farthest portraits based on a preset optimization principle of composition line, and the panoramic image frame, to acquire a first merged composition and two first single-object compositions;
when an actual scaling factor of the first merged composition is less than the sum of an actual scaling factor of any of the first single-object compositions and a preset first threshold, taking each of the first single-object compositions as a subclass center, otherwise, taking the first merged composition as the subclass center;
obtaining one subclass center from the respective subclass centers as a center to be processed;
when the portraits whose coverage rate of being covered by the portrait corresponding to the center to be processed exceeds a preset second threshold are present in the respective groups of the similar portraits, taking a portrait whose coverage rate exceeds a preset second threshold as one object of the composition object pair, and taking respective portrait corresponding to the center to be processed as the one object of the composition object pair;
when the portraits whose coverage rate of being covered by the portrait corresponding to the center to be processed exceeds the preset second threshold are not present in the respective groups of the similar portraits, taking the respective portrait corresponding to the center to be processed as the one object of the composition object pair, and taking the portrait that is closest to a center point of the center to be processed in the group to be processed as the one object of the composition object pair;
performing separately merging and cropping composition and single-object cropping composition on the composition object pair based on the preset optimization principle of composition line, and the panoramic image frame, to acquire a second merged composition and two second single-object compositions;
when the actual scaling factor of the second merged composition is less than the sum of the actual scaling factor of any of the second single-object compositions and the first threshold, taking each of the second single-object compositions as the subclass center, otherwise, taking the second merged composition as the subclass center, and deleting the subclass center corresponding to the center to be processed;
repeating the obtaining the subclass center from the respective subclass centers as the center to be processed, until the subclass center corresponding to each portrait in the group to be processed is determined;
repeating the obtaining the one group of similar portraits from the sorted respective groups of the similar portraits as the portrait group to be processed by using a manner of obtaining from the first one in the order, until obtaining all of the respective groups of the similar portraits in the respective groups of the similar portraits is completed; and
taking each of the subclass centers as the portrait composition.

5. The video processing method of claim 4, wherein the performing separately merging and cropping composition and single-object cropping composition on the pair of farthest portraits based on the preset optimization principle of composition line, and the panoramic image frame, to acquire the first merged composition and the two first single-object compositions further comprises:
performing separately merging and cropping composition and single-object cropping composition on the panoramic image frame based on a preset cropping size and the pair of farthest portraits to obtain respective initial compositions;
drawing respective composition lines for each of the initial compositions based on a preset drawing rule of composition line, wherein the preset drawing rule of composition line is that each of the composition lines is evenly distributed by 1/n of image width and 1/m of image height, and n and m are integers greater than 0;
adjusting an image magnification for each of the initial compositions based on the preset optimization principle of composition line, wherein the preset optimization principle of composition line is to adjust the image magnification so that a deviation value between a face position in an image and a closest horizontal composition line, and a deviation value between the face position in the image and a closest vertical composition line are both less than a preset third threshold;
when a cropping mode of the initial composition is merge cropping, taking the initial composition as the first merge composition; and
when the cropping mode of the initial composition is single-object cropping, taking the initial composition as the first single-object composition.

6. The video processing method of claim 1, wherein the determining single frame display data based on the respective portrait compositions further comprises:
performing spatial mapping layout on the respective portrait compositions based on a preset layout determination rule and the number of portrait compositions, to acquire the single frame display data;
wherein the layout determination rule includes minimizing a sum of distance differences; and
taking a position of a center point of the respective portrait compositions in the panoramic image frame as an original position, taking the position of the center point of the respective portrait compositions in the single frame display data as a layout position, taking a distance between the layout position of the same portrait composition and the original position as a distance difference, and adding the distance differences to obtain the sum of the distance differences.

7. The video processing method of claim 1, wherein the determining single frame display data based on the respective portrait compositions further comprises:
obtaining a target audio data corresponding to the panoramic image frame, and performing sound source information recognition on the target audio data;
determining a target sound source personnel based on sound source information and the portrait layout information;
when the target sound source personnel is absent, performing the spatial mapping layout on the respective portrait compositions based on the preset layout determination rule and the number of portrait compositions to acquire the single frame display data;
when the target sound source personnel is present, obtaining a transmission mode corresponding to the panoramic image frame;
when the transmission mode is a single stream transmission, performing the spatial mapping layout on the respective portrait compositions based on a preset speaker highlighting rule, the preset layout determination rule, the number of portrait compositions, and the target sound source personnel, to acquire the single frame display data; and
when the transmission mode is a branched transmission, marking the portrait composition corresponding to the target sound source personnel and taking the respective portrait compositions as the single frame display data.

8. A computer device, comprising a memory and a processor, wherein the memory configured to store a computer program, wherein the computer program, when executed by the processor, cause the processor to perform operations comprising:
obtaining a portrait cropping request;
performing portrait layout information recognition on a panoramic image frame corresponding to the portrait cropping request;
performing portrait grouping on the panoramic image frame to acquire respective groups of similar portraits based on a preset principle of a distance between each portrait and a camera, and the portrait layout information;
performing portrait cropping composition on the panoramic image frame to acquire respective portrait compositions based on the respective groups of the similar portraits; and
determining single frame display data based on the respective portrait compositions.

9. The computer device of claim 8, wherein before the obtaining the portrait cropping request, the operations further comprise:
obtaining the panoramic image frame;
when the number of the portraits in the panoramic image frame is 0, taking the panoramic image frame as the single frame display data; and
when the number of the portraits in the panoramic image frame is not 0, generating the portrait cropping request based on the panoramic image frame.

10. The computer device of claim 8, wherein the performing portrait grouping on the panoramic image frame to acquire the respective groups of the similar portraits based on the preset principle of the distance between each portrait and the camera, and the portrait layout information further comprises:
recognizing a distance between each portrait and the camera in the panoramic image frame to acquire a distance between the single portrait and the camera based on a preset distance calculation rule and the portrait layout information;
grouping the portraits in the panoramic image frame according to the preset principle of the distance between each portrait and the camera, and the distance between the single portrait and the camera, and further based on a preset grouping index configuration, to acquire the respective groups of the similar portraits;
wherein the preset grouping index configuration comprises: a maximum camera distance absolute difference within one of the groups is less than a preset first distance, and an average absolute difference of camera distances between each two of the groups is greater than a preset second distance; and
the preset distance calculation rule comprises any one of a depth of a center point of the portrait, a maximum supported scaling factor, or an area of a portrait detection box.

11. The computer device of claim 8, wherein the performing portrait cropping composition on the panoramic image frame to acquire the respective portrait compositions based on the respective groups of the portraits further comprises:
sorting the respective groups of the similar portraits in positive order based on an average distance of each group;
obtaining one of the groups of the similar portraits from the sorted respective groups of the similar portraits as a portrait group to be processed by using a manner of obtaining from the first one in the order;
identifying two portraits having a maximum distance between the single portrait and the camera from the portrait group to be processed as a pair of farthest portraits;
performing separately merging and cropping composition and single-object cropping composition on the pair of farthest portraits based on a preset optimization principle of composition line, and the panoramic image frame, to acquire a first merged composition and two first single-object compositions;
when an actual scaling factor of the first merged composition is less than the sum of an actual scaling factor of any of the first single-object compositions and a preset first threshold, taking each of the first single-object compositions as a subclass center, otherwise, taking the first merged composition as the subclass center;
obtaining one subclass center from the respective subclass centers as a center to be processed;
when the portraits whose coverage rate of being covered by the portrait corresponding to the center to be processed exceeds a preset second threshold are present in the respective groups of the similar portraits, taking a portrait whose coverage rate exceeds a preset second threshold as one object of the composition object pair, and taking respective portrait corresponding to the center to be processed as the one object of the composition object pair;
when the portraits whose coverage rate of being covered by the portrait corresponding to the center to be processed exceeds the preset second threshold are not present in the respective groups of the similar portraits, taking the respective portrait corresponding to the center to be processed as the one object of the composition object pair, and taking the portrait that is closest to a center point of the center to be processed in the group to be processed as the one object of the composition object pair;
performing separately merging and cropping composition and single-object cropping composition on the composition object pair based on the preset optimization principle of composition line, and the panoramic image frame, to acquire a second merged composition and two second single-object compositions;
when the actual scaling factor of the second merged composition is less than the sum of the actual scaling factor of any of the second single-object compositions and the first threshold, taking each of the second single-object compositions as the subclass center, otherwise, taking the second merged composition as the subclass center, and deleting the subclass center corresponding to the center to be processed;
repeating the obtaining the subclass center from the respective subclass centers as the center to be processed, until the subclass center corresponding to each portrait in the group to be processed is determined;
repeating the obtaining the one group of the similar portraits from the sorted respective groups of the similar portraits as the portrait group to be processed by using a manner of obtaining from the first one in the order, until obtaining all of the respective groups of the similar portraits in the respective groups of the similar portraits is completed; and
taking each of the subclass centers as the portrait composition.

12. The computer device of claim 11, wherein the performing separately merging and cropping composition and single-object cropping composition on the pair of farthest portraits based on the preset optimization principle of composition line, and the panoramic image frame, to acquire the first merged composition and the two first single-object compositions further comprises:
performing separately merging and cropping composition and single-object cropping composition on the panoramic image frame based on a preset cropping size and the pair of farthest portraits to obtain respective initial compositions;
drawing respective composition lines for each of the initial compositions based on a preset drawing rule of composition line, wherein the preset drawing rule of composition line is that each of the composition lines is evenly distributed by 1/n of image width and 1/m of image height, and n and m are integers greater than 0;
adjusting an image magnification for each of the initial compositions based on the preset optimization principle of composition line, wherein the preset optimization principle of composition line is to adjust the image magnification so that a deviation value between a face position in an image and a closest horizontal composition line, and a deviation value between the face position in the image and a closest vertical composition line are both less than a preset third threshold;
when a cropping mode of the initial composition is merge cropping, taking the initial composition as the first merge composition; and
when the cropping mode of the initial composition is single-object cropping, taking the initial composition as the first single-object composition.

13. The computer device of claim 8, wherein the determining single frame display data based on the respective portrait compositions further comprises:
performing spatial mapping layout on the respective portrait compositions based on a preset layout determination rule and the number of portrait compositions, to acquire the single frame display data;
wherein the layout determination rule includes minimizing a sum of distance differences; and
taking a position of a center point of the respective portrait compositions in the panoramic image frame as an original position, taking the position of the center point of the respective portrait compositions in the single frame display data as a layout position, taking a distance between the layout position of the same portrait composition and the original position as a distance difference, and adding the distance differences to obtain the sum of the distance differences.

14. The computer device of claim 8, wherein the determining single frame display data based on the respective portrait compositions further comprises:
obtaining a target audio data corresponding to the panoramic image frame, and performing sound source information recognition on the target audio data;
determining a target sound source personnel based on sound source information and the portrait layout information;
when the target sound source personnel is absent, performing the spatial mapping layout on the respective portrait compositions based on the preset layout determination rule and the number of portrait compositions to acquire the single frame display data;
when the target sound source personnel is present, obtaining a transmission mode corresponding to the panoramic image frame;
when the transmission mode is a single stream transmission, performing the spatial mapping layout on the respective portrait compositions based on a preset speaker highlighting rule, the preset layout determination rule, the number of portrait compositions, and the target sound source personnel, to acquire the single frame display data; and
when the transmission mode is a branched transmission, marking the portrait composition corresponding to the target sound source personnel and taking the respective portrait compositions as the single frame display data.

15. A non-transitory computer-readable medium storing instructions that, when executed by a processor, cause the processor to perform operations comprising:
obtaining a portrait cropping request;
performing portrait layout information recognition on a panoramic image frame corresponding to the portrait cropping request;
performing portrait grouping on the panoramic image frame to acquire respective groups of similar portraits based on a preset principle of a distance between each portrait and a camera, and the portrait layout information;
performing portrait cropping composition on the panoramic image frame to acquire respective portrait compositions based on the respective groups of the similar portraits; and
determining single frame display data based on the respective portrait compositions.

16. The non-transitory computer-readable medium of claim 15, wherein before the obtaining the portrait cropping request, the operations further comprise:
obtaining the panoramic image frame;
when the number of the portraits in the panoramic image frame is 0, taking the panoramic image frame as the single frame display data; and
when the number of the portraits in the panoramic image frame is not 0, generating the portrait cropping request based on the panoramic image frame.

17. The non-transitory computer-readable medium of claim 15, wherein the performing portrait grouping on the panoramic image frame to acquire the respective groups of the similar portraits based on the preset principle of the distance between each portrait and the camera, and the portrait layout information further comprises:
recognizing a distance between each portrait and the camera in the panoramic image frame to acquire a distance between the single portrait and the camera based on a preset distance calculation rule and the portrait layout information;
grouping the portraits in the panoramic image frame according to the preset principle of the distance between each portrait and the camera, and the distance between the single portrait and the camera, and further based on a preset grouping index configuration, to acquire the respective groups of the similar portraits;
wherein the preset grouping index configuration comprises: a maximum camera distance absolute difference within one of the groups is less than a preset first distance, and an average absolute difference of camera distances between each two of the groups is greater than a preset second distance; and
the preset distance calculation rule comprises any one of a depth of a center point of the portrait, a maximum supported scaling factor, or an area of a portrait detection box.

18. The non-transitory computer-readable medium of claim 15, wherein the performing portrait cropping composition on the panoramic image frame to acquire the respective portrait compositions based on the respective groups of the portraits further comprises:
sorting the respective groups of the similar portraits in positive order based on an average distance of each group;
obtaining one of the groups of the similar portraits from the sorted respective groups of the similar portraits as a portrait group to be processed by using a manner of obtaining from the first one in the order;
identifying two portraits having a maximum distance between the single portrait and the camera from the portrait group to be processed as a pair of farthest portraits;
performing separately merging and cropping composition and single-object cropping composition on the pair of farthest portraits based on a preset optimization principle of composition line, and the panoramic image frame, to acquire a first merged composition and two first single-object compositions;
when an actual scaling factor of the first merged composition is less than the sum of an actual scaling factor of any of the first single-object compositions and a preset first threshold, taking each of the first single-object compositions as a subclass center, otherwise, taking the first merged composition as the subclass center;
obtaining one subclass center from the respective subclass centers as a center to be processed;
when the portraits whose coverage rate of being covered by the portrait corresponding to the center to be processed exceeds a preset second threshold are present in the respective groups of the similar portraits, taking a portrait whose coverage rate exceeds a preset second threshold as one object of the composition object pair, and taking respective portrait corresponding to the center to be processed as the one object of the composition object pair;
when the portraits whose coverage rate of being covered by the portrait corresponding to the center to be processed exceeds the preset second threshold are not present in the respective groups of the similar portraits, taking the respective portrait corresponding to the center to be processed as the one object of the composition object pair, and taking the portrait that is closest to a center point of the center to be processed in the group to be processed as the one object of the composition object pair;
performing separately merging and cropping composition and single-object cropping composition on the composition object pair based on the preset optimization principle of composition line, and the panoramic image frame, to acquire a second merged composition and two second single-object compositions;
when the actual scaling factor of the second merged composition is less than the sum of the actual scaling factor of any of the second single-object compositions and the first threshold, taking each of the second single-object compositions as the subclass center, otherwise, taking the second merged composition as the subclass center, and deleting the subclass center corresponding to the center to be processed;
repeating the obtaining the subclass center from the respective subclass centers as the center to be processed, until the subclass center corresponding to each portrait in the group to be processed is determined;
repeating the obtaining the one group of the similar portraits from the sorted respective groups of the similar portraits as the portrait group to be processed by using a manner of obtaining from the first one in the order, until obtaining all of the respective groups of the similar portraits in the respective groups of the similar portraits is completed; and
taking each of the subclass centers as the portrait composition.

19. The non-transitory computer-readable medium of claim 15, wherein the determining single frame display data based on the respective portrait compositions further comprises:
performing spatial mapping layout on the respective portrait compositions based on a preset layout determination rule and the number of portrait compositions, to acquire the single frame display data;
wherein the layout determination rule includes minimizing a sum of distance differences; and
taking a position of a center point of the respective portrait compositions in the panoramic image frame as an original position, taking the position of the center point of the respective portrait compositions in the single frame display data as a layout position, taking a distance between the layout position of the same portrait composition and the original position as a distance difference, and adding the distance differences to obtain the sum of the distance differences.

20. The non-transitory computer-readable medium of claim 15, wherein the determining single frame display data based on the respective portrait compositions further comprises:
obtaining a target audio data corresponding to the panoramic image frame, and performing sound source information recognition on the target audio data;
determining a target sound source personnel based on sound source information and the portrait layout information;
when the target sound source personnel is absent, performing the spatial mapping layout on the respective portrait compositions based on the preset layout determination rule and the number of portrait compositions to acquire the single frame display data;
when the target sound source personnel is present, obtaining a transmission mode corresponding to the panoramic image frame;
when the transmission mode is a single stream transmission, performing the spatial mapping layout on the respective portrait compositions based on a preset speaker highlighting rule, the preset layout determination rule, the number of portrait compositions, and the target sound source personnel, to acquire the single frame display data; and
when the transmission mode is a branched transmission, marking the portrait composition corresponding to the target sound source personnel and taking the respective portrait compositions as the single frame display data.
